(19) United States
(12) Patent Application Publication
(10) Pub. No.: US 2014/0249935 A1
(43) Pub. Date: Sep. 4, 2014

(54) SYSTEMS AND METHODS FOR FORWARDING USERS TO MERCHANT WEBSITES

(71) Applicants: Francis Furst Daily, IV, Hunt Valley, MD (US); Michael Seamus Maloney, New York, NY (US); Pearce Ferhan Erensel, New York, NY (US); Andre Michael Jordan, Franklin Lakes, NJ (US); Keith Anderson Bolles, Essex, CT (US); Philippe Jordan, New York, NY (US)

(72) Inventors: Francis Furst Daily, IV, Hunt Valley, MD (US); Michael Seamus Maloney, New York, NY (US); Pearce Ferhan Erensel, New York, NY (US); Andre Michael Jordan, Franklin Lakes, NJ (US); Keith Anderson Bolles, Essex, CT (US); Philippe Jordan, New York, NY (US)

(21) Appl. No.: 13/784,057

(22) Filed: Mar. 4, 2013

(51) Int. Cl. G06Q 30/02

(52) U.S. Cl. CPC G06Q 30/0277
USPC 705/14.73

(57) ABSTRACT

An advertising system is disclosed for connecting consumers with merchant websites and interfaces that are associated with products displayed in an image. For each product in an image, a selectable region may be defined using a set of coordinates that identify the displayed product. In response to receiving an input from a user in the selectable region of the image that is associated with the product, the user may be forwarded to a web page associated with the product. The web page associated with the product may permit the user to purchase the product or disclose details relating to the product.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present principles are directed to systems and methods for a digital advertising system, and more particularly, to providing an advertising system that utilizes mapped images to connect consumers with merchant websites.

### BACKGROUND OF THE INVENTION

Currently, a number of methods exist for purchasing a product over the Internet. For example, a user can utilize a web browser to search for the Internet for a website provided by a merchant (e.g., retailer, designer or manufacturer) that sells the product, and then search the merchant's website to locate and purchase the product. As another alternative, a user can utilize a search engine to locate and purchase a product. For example, a user can type the name of a product directly into a search engine (e.g., Google™) and the search engine will display a list of search results, some of which include images of the product and hyperlinks to merchant websites that sell the product. As an even further alternative, a user may purchase a product over the Internet by clicking on an advertisement in an email and navigating to a merchant website that sells the product.

However, it is not unusual for a user browsing a website to come across a product in an image that the user is interested in purchasing. For example, a user reading a blog on a website or browsing another type of website may see a product (e.g., a bag, shirt, pair of shoes, etc.) in an image that the user desires to purchase. Unfortunately, the user often has no way of knowing the brand of the product, the name of the product or where to purchase the product. Even if the user is able to identify the name or brand of the product (e.g., by identifying a logo on the product), the user must research how to obtain or purchase the product. For example, as explained above, the user may be required to initially identify or locate a website associated with the manufacturer or retailer of the product, and then search the website to find the product. Thus, there is no way for a user to quickly and efficiently locate and purchase the desired product displayed in the image.

In view of the foregoing, there is a need for an advertising system that allows for the identification of products in an image and which connects consumers directly with websites or web pages that are associated with the products in the image.

### SUMMARY OF THE INVENTION

In accordance with the principles described herein, an advertising system is disclosed for connecting consumers with merchant websites and interfaces that are associated with products displayed in an image. For one or more products displayed in an image, a selectable region may be defined using a set of coordinates that identify the displayed product. In response to receiving an input from a user in the selectable region of the image that is associated with the product, the user may be forwarded to a web page associated with the product. The web page associated with the product may permit the user to purchase the product or disclose details relating the product.

In accordance with certain embodiments, a method is provided for providing an advertising service. The method includes transmitting a mapped image that displays a product over a network for display in a web browser. The mapped image includes a selectable region covering at least a portion of the mapped image which includes the product and is associated with a set of image coordinates that identify the portion of the mapped image. The method further includes determining a network address that is associated with the selectable region of the mapped image and which identifies a web page associated with purchasing the product. Data is transmitted over the network for detecting an input in the selectable region of the mapped image from the user and for forwarding the user to the web page associated with the network address in response to detecting the input in the selectable region of the mapped image.

In accordance with certain embodiments, a system is disclosed for providing an advertising service. The system includes a processor which is configured to transmit a mapped image that displays a product and which includes a selectable region to a user over a network for display in a web browser. The selectable region of the mapped image covers at least a portion of the mapped image which includes the product and is associated with a set of image coordinates that identify the portion of the mapped image. The processor is further configured to determine a network address that is associated with the selectable region of the mapped image and transmit data over the network for detecting an input in the selectable region of the mapped image from the user and for forwarding the user to a web page associated with the network address in response to detecting the input in the selectable region of the mapped image.

These and other features and advantages will become apparent from the following detailed description of illustrative embodiments thereof, which is to be read in connection with the accompanying drawings.

### BRIEF DESCRIPTION OF DRAWINGS

The inventive principles are illustrated in the figures of the accompanying drawings which are meant to be exemplary and not limiting, in which like references are intended to refer to like or corresponding parts, and in which:

FIG. 1 is a block diagram of an operating environment for use with certain embodiments of the present invention.

FIG. 2 is an illustration of a mapped image in accordance with certain embodiments of the present invention.

FIG. 3 is a detailed view of an exemplary advertising system in accordance with certain embodiments of the present invention.

FIG. 4 is a method for providing an advertising service in accordance with certain embodiments of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

System and methods are disclosed for providing an advertising system that associates portions of an image with product information listed on one or more merchant websites. Initially, one or more products in an image may be identified. An image map may be generated for the image that specifies one or more selectable regions on the image using a set of coordinates, and which further associates each selectable region with a network address, such as an internet protocol (IP) address or uniform resource locator (URL). Each of the selectable regions represents a separate hyperlink and is associated with a product displayed in the image. In response to receiving an input from a user in a selectable region, the user is redirected or forwarded to the network address associated with the selectable region. Any type of input may be received in the selectable region to cause the user to be redirected or forwarded to the network address associated with the selectable region. Exemplary inputs may include a mouse click, a hover event (e.g., on MouseOver event), a gesture received via a touch screen device (e.g., a tap, double tap, swipe, etc.) or any other type of input.

In certain embodiments, receiving an input in a selectable region will forward the user to a network address for a merchant's website that sells the product and, in particular, may forward the user to the particular web page on the merchant's website that lists the product for sale. In other embodiments, receiving an input in a selectable region will forward the user to a network address of a web page that compares prices for the product offered by different merchants and which provides links to the merchant websites being compared. In other embodiments, receiving an input in a selectable region may forward the user to a checkout page on a merchant website for purchasing the product or to an electronic shopping cart on a merchant website in which the product has been added to the shopping cart. In even further embodiments, receiving an input in a selectable region will forward the user to a network address that displays further information about the product or a topic related to the product.

The manner in which the image map, which identifies the products via selectable regions, is generated may vary. In certain embodiments, this may be performed manually, e.g., by a developer that manually specifies the coordinates of the selectable regions in an HTML file or other type of web page that includes the image. In other embodiments, the generation of the image map may be performed by an automated tool that permits a non-technical user with little or no programming experience to specify the selectable regions (and associated coordinates) for the products in an image.

In certain embodiments, a set of coordinates associated with a selectable region of an image may be statically defined within a web page or related file. In other embodiments, the set of coordinates associated with a selectable region may be dynamically determined each time a web page including the image is loaded. In the case that the dimensions of the image have changed, a scaling procedure may be applied to define a new set of coordinates for the image. For example, an original set of coordinates for an image having a first set of dimensions may initially be defined and stored to identify a product in the image. In response to detecting that the dimensions for the image have been modified, a scaling procedure may compute a second set of coordinates for the image which correspond to the portions of the image that identify the product. Thus, if the dimensions of an image are altered, the coordinates defining a selectable region can also be altered accordingly to ensure that the selectable region covers the portion of the image that identifies the product.

In certain embodiments, a network address associated with a selectable region of an image may be statically defined within a web page or related file. In other embodiments, the network address may be dynamically determined each time a web page including the image is loaded. This may include accessing an entry in a database that is associated with the image to retrieve the network address for the selectable region of the image. The entry in the database specifying the network address for the selectable region may be modified by a developer or website administrator, or in response to certain events (e.g., in response to detecting that the product associated with the selectable region is being offered for less money by a different merchant or in response to a merchant purchasing leads or advertising credits for the product that is associated with the selectable region).

An activity tracking system may also be utilized to monitor and record data relating to a user's interaction with a mapped image and/or website that displays a mapped image. This may include tracking data related to forwarding a user to a network address associated with a selectable region and tracking data associated with displaying a product preview feature (described below). Each time a user provides an input to a selectable region on the image, data may be recorded which identifies the IP address of the user, the product associated with the selectable region, the network address associated with the selectable region, the physical location of the user, a timestamp indicating the time that the input was received, and other types of related information. In the case that the user was logged into an account on the host website (e.g., the website that displays the mapped image), additional information may also be recorded that relates to the user's account (e.g., such as a user ID, contact information or other information related to the user or the user's account).

The data recorded by the activity tracking system may be utilized in different ways. In certain embodiments, the data may be used to track the interests or shopping patterns of a user that is identified by a particular IP address and/or user ID. The advertising system may then recommend other products and services to the user based on the user's interests and/or shopping patterns, or based on common interests and/or shopping patterns with other users. The information may further be used to determine whether advertising goals are being met (e.g., by determining how many users have been forwarded to merchant sites) and to analyze trends of users that are accessing the website on a host server that stores the image. The activity tracking information may also be sold to third parties (e.g., advertisers, resellers, manufacturers, etc.).

A product preview feature is also provided which displays or previews one or more products in an image that have been identified by selectable regions. For example, a user may see a product (e.g., a bag or jacket) in an image that the user is interested in, but may not know anything about the product such as the brand of the product or the price of the product. Therefore, the product preview feature may provide relevant information to the user about the product without requiring the user to navigate to the network address associated with a selectable region. In certain embodiments, the product preview feature causes a pop-up window or overlay element to be displayed on an interface that is presented to a user in response to detecting an input by the user (e.g., in response to the user scrolling over a selectable region). The product preview feature may display information about the product such pricing information, thumbnail images, product descriptions, merchant information, and other types of data associated with the product. This information displayed by the product preview feature may be read in from a database on a host website that displays the mapped image or from a third party database including product information. If the user is interested in purchasing the product or finding out further information about the product, the user may then navigate to the network address associated with the selectable region. Any type of input may be utilized to trigger the product preview feature. In many cases, the input utilized to trigger the product preview feature is a different type of input that is utilized to forward a user to a network address associated with a mapped image.

In certain embodiments, the principles described herein may be extended for use with different types of applications (e.g., mobile applications, desktop applications, kiosk applications, television applications, etc.). For example, rather than displaying the mapped image on a website to a user, the mapped image may be displayed to a user via an application such as a mobile application that is installed on a mobile device (e.g., a smart phone, tablet device or other type of mobile device). In response to receiving an input in a selectable region of the mapped image which is associated with a product, a web browser on a user's mobile device may display a website that is associated with the product. In other embodiments, the mapped image may be displayed to a user via a web browser on the mobile device (e.g., if the user is browsing websites on the mobile device). In response to receiving an input in the selectable region of the mapped image which is associated with a product, an application installed on the mobile device may be executed and the application may display an interface that permits the user to purchase the product (e.g., a shopping cart interface, checkout page interface, product listing interface, etc.). Similar principles may be applied to applications that are provided on other types of devices (e.g., applications installed on smart televisions, kiosks, desktop computers, motor vehicles, etc.).

Embodiments described herein may be hardware-based, software-based and preferably comprise a mixture of both hardware and software elements. Thus, while the description herein may describe certain embodiments, features or components as being implemented in software or hardware, it should be recognized that any embodiment, feature or component that is described in the figures or description of the present application may be implemented in hardware and/or software. In certain embodiments, particular aspects are implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

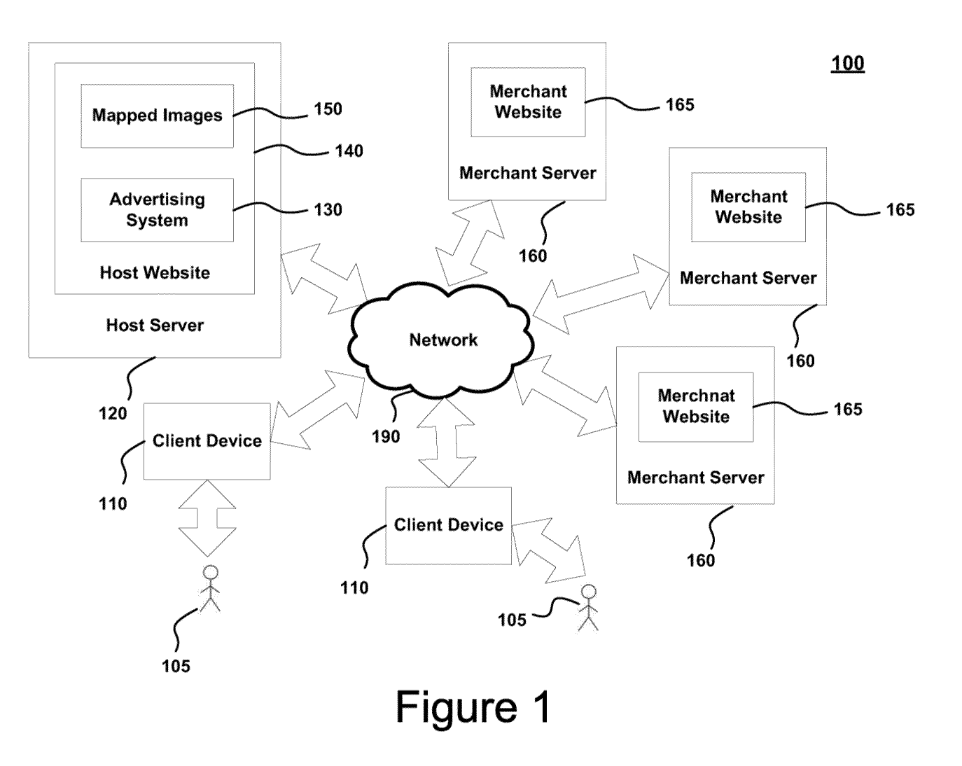

Referring now to the drawings in which like numerals represent the same or similar elements and initially to FIG. 1, an operating environment 100 for use with certain embodiments of the present invention. As shown therein, a plurality of client devices 110 are in communication with a host server 120 and a plurality of merchant servers 160 over a network 190. The network 190 may be any type of network such as one that includes the Internet, a local area network, a wide area network, an intranet, etc. The client devices 110, the host server 120, and the merchant servers 160 may be configured to communicate via wired or wireless links, or a combination of the two.

The client devices 110 may represent a desktop computer, laptop computer, cell phone, tablet device, or other type of computing device. Each of the client devices may be equipped with one or more computer storage devices (e.g., RAM, ROM, PROM, SRAM, etc.) and one or more processing devices (e.g., a central processing unit) that are capable of executing computer program instructions. Computer storage device is preferably a physical, non-transitory medium.

Any of the client devices 100 may further include a display that is capable of rendering an interface and one or more input devices (e.g., keyboard, microphone, camera, video camera, scanner, joystick, touch screen input devices, remote control device, etc.). Users 105 may manipulate interfaces rendered on the display using the input devices to communicate with the hosting server 120 and merchant servers 160.

The host server 120 and merchant servers 160 may also include one or more processors and one or more computer storage devices. Computer storage device is preferably a physical, non-transitory medium. The host server 120 and merchant servers 160 may generally represent any type of computing device that is capable of communicating with a client device 110. In certain embodiments, the hosting server 120 and merchant servers 160 comprise one or more mainframe computing devices that execute a web server for communicating with client devices 110 over the Internet.

The host server 120 may represent any server that hosts or stores a mapped image 150. The storage medium on the host server 120 can store data and files related to providing a host website 140 and an advertising system 130 (discussed in further detail below). The host website 140 may represent any type of website that includes a mapped image 150 including, but not limited to, a website that is associated with a blog, eCommerce, advertising, social networking, message boards, education, business, gaming, or any other type of website. The mapped images 150 may be displayed on the host website 140. In general, the mapped image 150 represents an image associated with an image map that defines one or more selectable regions on the image 150 which correspond to one or more products displayed in the image 150, and which specifies a network address (e.g., which identifies merchant website 165) that is associated with the product. The image map may specify a selectable region for the image 150 using a set of coordinates. Each selectable region provides a hyperlink to the network address that is associated with the product identified by the selectable region. In response to receiving an input in a selectable region of an image, a web browser being utilized by a user 105 may be forwarded to a website or web page that is identified by the network address.

The network address may represent an internet protocol (IP) address, uniform resource locator (URL) or uniform resource identifier (URI) associated with a merchant website 165 being hosted on a merchant server 160 or other type of web page. In general, the merchant website 165 may represent any website that is associated with a product or service in the mapped image 150. In certain embodiments, the merchant website 165 may represent a website associated with a manufacturer that produces the product, a designer that created the product, a wholesaler associated with distributing the product, or a retailer that sells the product. The merchant website 165 may represent other types of websites as well.

A network address may identify various types of web pages associated with a merchant website 165. For example, the network address may refer to a web page on the merchant's website 165 that lists a product for sale, a web page that provides a detailed description of the product (e.g., including the product specs, pricing information, size, functionality, etc.), a checkout page on a merchant website that permits the user 105 to purchase the product, a web page that displays an electronic shopping cart that includes the product in the shopping cart, or a homepage for the merchant website 165. In certain embodiments, the network address identifies a web page that compares pricing information from different merchant websites 165 for a product in a mapped image 150 and which provides links to the merchant websites 165 being compared.

It should be recognized that in some cases the network address may refer to a web page that is included as part of the host website 140 (e.g., the network address may represent an internal link within a website). The internal link may identify similar types of web pages as those described above with respect to the merchant websites 165. For example, the network address may identify a web page on the host website 140 that is associated with a product listing, product description, checkout page or shopping cart on the host website 140. As explained above, the network address may also identify a web page that compares pricing information for a product. This web page may be provided as part of the host website 140, merchant website 165 or any other website.

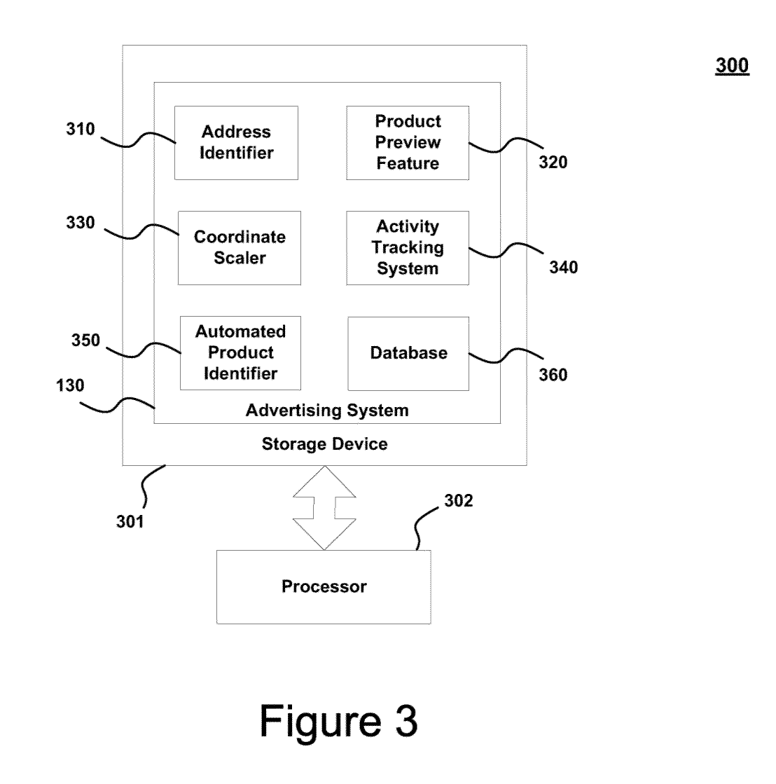

An advertising system 130 may assist with providing several features and functions which are associated with the mapped image 150. As will be explained in further detail below with reference to FIG. 3, the advertising system 130 may provide an automated tool that assists a developer or other person with generating the mapped image 150 and its associated image map. The advertising system 130 may permit the network addresses associated with selectable areas of a mapped image 150 to be determined dynamically each time the mapped image 150 is loaded and may further permit the network addresses to be updated or modified. The advertising system 130 may further provide a function for automatically scaling coordinate values associated a mapped image 150 in response to detecting that the dimensions of a mapped image 150 have changed.

Other functions provided by the advertising system 130 may include providing a preview feature that displays information about a product associated with a selectable region without requiring the user 105 to navigate to the network address associated with the selectable region. The advertising system 130 may further include functions for monitoring and recording activity data for a user 105. This may include monitoring and recording activity data that relates to a user's interaction with a mapped image 150 or which relates to other activities that the user engages in on the host website 140.

In certain embodiments, the advertising system 130 may be located or stored on the host server 120. In the exemplary embodiment disclosed in FIG. 1, the advertising system 130 is integrated with the host website 130. For example, the advertising system 130 may be integrated with the host website 140 in the sense that the software code and/or HTML code associated with providing the features of the advertising system 130 are directly included within the files of the web pages associated with the host website 140 (e.g., embodied as HTML tags and scripting code within web pages or external files that are utilized by the web pages).

It should be noted that the system in FIG. 1 is merely meant to demonstrate an embodiment of an operating environment 100 that can be utilized in conjunction with the principles taught herein, and should not be construed as limiting in any manner whatsoever. The particular configuration in FIG. 1 can be altered in numerous ways without departing from the principles herein. For example, it should be noted that the functionality of the host server 120 in FIG. 1 may be carried out by a plurality of servers. Likewise, although the figure depicts three merchant servers 160 and two client devices 110, any number of merchant servers 160 and client devices 110 may be utilized with the system and the system may be configured in a variety of different ways (e.g., in a distributed computing environment, cloud-based environment, client-server environment, etc.).

It should also be recognized while the present disclosure may describe the selectable areas as being associated with a product, it should be understood that the selectable areas may also identify a service that is identified in an image and provide hyperlinks to information (e.g., pricing information, description, etc.) relating to the identified service. Thus, for the purposes of this disclosure, the term “product” should also be meant to encompass services as well.

Also, although the description herein may describe the mapped image 150 as being provided by a host website 140 and/or host server 120, the mapped image 150 displayed via the host website 140 may be retrieved from a third party (e.g., an advertising service, retailers, manufacturers, etc.) over the network 190 and incorporated into a web page for the host website 140 for display to the user 105. Thus, there is no requirement that the mapped image 150 is stored on the host server 140 and in many cases the host server 140 may retrieve the mapped image 150 (e.g., may retrieve both the image and associated mapping information) from a third party.

Even further, in certain embodiments, the principles described herein may be extended for use with various types of applications (e.g., mobile applications, desktop applications, kiosk applications, television applications, motor vehicle applications, etc.). For example, in the case of a mobile application, the mapped image may be displayed to a user via a mobile application that is installed on a mobile device such as a smart phone or tablet device. In response to receiving an input (e.g., an tap on a touch screen) in a selectable region of the mapped image which is associated with a product, a web browser on a user's mobile device may display a website that is associated with the product. Alternatively, in certain embodiments, the mapped image may be displayed to a user via a web browser on the mobile device and an application installed on the mobile device may be executed in response to receiving an input in the selectable region of the mapped image which is associated with a product. The application which is launched may display an interface that permits the user to purchase the product (e.g., a shopping cart interface, checkout page interface, product listing interface, etc.). Similar principles may be applied to other types of applications (e.g., applications installed on smart televisions, kiosks, desktop computers, motor vehicles, etc.) in the same or similar manner.

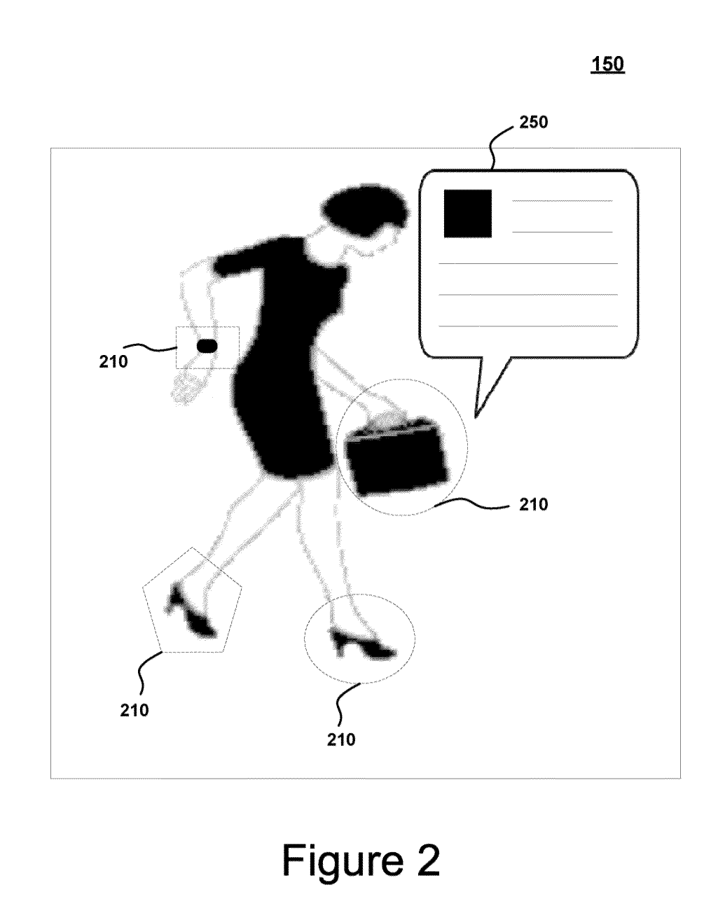

FIG. 2 illustrates an exemplary mapped image 150 in accordance with certain embodiments of the present invention. As shown therein, the mapped image includes a plurality of selectable regions 210. Each of the selectable regions 210 identify a product that is displayed in the mapped image 150. In addition, each of the selectable regions 210 include a hyperlink that identifies a network address associated with the product that is displayed in the mapped image 150. As explained above, the network address may identify various types of web pages that are associated with the product, and in some cases may identify a merchant website 165 that sells the product.

The shape of a selectable area 120 may vary. As can be seen, the shape of the selectable area 120 associated with the bracelet in the image 150 is defined as a rectangle, while the shape of the selectable area associated with the bag and the right shoe are defined using circles. On the other hand, the shape of the selectable area 120 associated with the left shoe is defined using a polygon, which is a pentagon in this case. In certain embodiments, the “shape” attribute of the HTML area tag (i.e., <area>) can be varied to adjust the shape of the selectable region.

It should be noted that although the selectable areas 210 are identified by a dotted line in FIG. 2, the dotted line may not actually be displayed to a user 105 viewing the mapped image 150 on the host website 140. In fact, in preferred embodiments, the selectable areas 210 are not visible to the viewer 105.

Below is exemplary pseudocode that may be utilized to define an image map in accordance with certain embodiments of the present principles.

### Pseudocode Example #1:

```
<img src=“woman.gif” width=“600” height=“600” alt=“woman”
usemap=“#woman”>
<map name=“woman”>
    <area shape=“rect” coords=“190,200,210,220” alt=“bracelet”
href=“http://www.merchant1.html”>
    <area shape=“circle” coords=“325,305,30” alt=“bag” href=“
http://www.merchant2.html”>
    <area shape=“circle” coords=“295,450,15” alt=“rightShoe” href=“
http://www.merchant3.html”>
    <area shape=“polygon”
coords=“165,430,195,410,210,430,205,450,175,450”
alt=“leftShoe” href=“ http://www.merchant3.html”>
</map>
```

As can be seen, an HTML image tag identifies an image (i.e., “woman.gif”) and associates the image with an image map using the “usemap” attribute. The HTML map tag includes four HTML area tags that define the selectable regions 210 of the mapped image 150. Each area tag includes a set of coordinates for defining a selectable region 210 in accordance with a particular shape (i.e., a circle, rectangle, or polygon) and for defining a network address associated with the product that is displayed in the mapped image 150.

The mapped image 150 in FIG. 2 also includes a product preview window 250 which may display information about a product (e.g., which may provide a product description, pricing information and an image for the product) without requiring a user 105 to travel to another web page or website (e.g., a merchant website 165). In certain embodiments, the product preview window 250 may be displayed in response to a user scrolling over a selectable area 210. This product preview window 250 is useful because it may provide a user 105 with some basic information about a product displayed in an image 150 without requiring the user 105 to navigate to a separate web page or website.

In many cases, the product preview feature may include a feature that permits a user to recommend a product to another individual. For example, the product preview feature may permit a user 105 to send an email or text message (or other form of communication) to another user with information about the product that is displayed in the product preview feature. Further details regarding the product preview window 250 are discussed below in describing the preview feature 330 of FIG. 3.

Moving on to FIG. 3, a detailed view of an advertising platform 300 is disclosed in accordance with certain embodiment of the present invention. As shown therein, the advertising platform 300 includes a plurality of software components (e.g., address identifier 310, product preview feature 320, coordinate scaler 330, etc.) stored on a storage device 301 (e.g., RAM, ROM, PROM, SRAM, etc) for providing an advertising system 130. The memory device 301 is in communication with one or more processors 302 that may be configured to execute the instructions associated with software components.

It should be noted that although the components on the memory device 301 may be described throughout this disclosure as software modules, such is not necessary. Furthermore, while the components may be illustrated as separate and distinct components, it should be recognized the components can be combined in any manner (e.g., all of the components may be executed as a part of a single program or file, or as separately executing processes or threads) and that the functions performed by these components may overlap in some instances. In certain embodiments, the components may be directly incorporated into one or more web pages on the host website 140 using HTML tags and/or scripting code (e.g., JavaScript of PHP code).

The product identifier 350 may permit a developer, website administrator or other user to identify one or more products in a mapped image 150 and associate the one or more products with a web page (e.g., a web page on the merchant website 165). In certain embodiments, products may be identified manually. For example, a developer or user may manually specify the coordinates of the selectable regions in an HTML file, or other type of web page, using code similar to code in Pseudocode Example #1 provided above.

In other embodiments, the product identifier 350 may provide an automated tool for generating the mapped image 150 and associated image map. The automated tool permits a non-technical user with little or no programming experience to specify the selectable regions 210 for the products in an image and to associate the selectable regions with network addresses. For example, the automated tool may allow a user to upload an image or identify an image for which an image map is to be created. The selected image may then be displayed to a user in a window. A user may select a shape (e.g., circle) that is to be associated with a selectable region and specify associated parameters (e.g., radius of the circle defining the selectable region 210 and a network address to be associated with the selectable region). A user may then click on the portion of the displayed image (or provide other types of input) to identify or create a selectable region for a product in the image. The automated tool may automatically compute the coordinates for the selectable region based on the area that the user input (e.g., the mouse click) was received using the parameters specified by the user (e.g., using the radius value and network address that were entered by the user). In certain embodiments, the automated tool associated with the product identifier 350 for creating a mapped image 150 may output code (e.g., similar to that of Pseudocode Example #1) that may be copied or pasted into a web page. In other embodiments, the automated tool may directly incorporate code into a web page file or external file used by a web page.

The product identifier 350 may be included in a file stored on the host server 120 and presented as interface to a user via a web browser that permits the user to upload the image, identify selectable regions 210 and create a mapped image 150. In other embodiments, the product identifier 350 may be incorporated in a website development program (e.g., Adobe Dreamweaver™) that permits code to be directly incorporated into web pages that are being created.

The advertising system 130 also includes an address identifier 310 that determines or identifies network addresses that are to be associated with selectable regions 210 of a mapped image 150. In certain embodiments, the network addresses may be specified directly in a web page (e.g., as in Pseudocode Example #1) associated with the host website 140. In other embodiments, the address identifier 310 may determine the network addresses dynamically each time the mapped image 150 or web page including the mapped image 150 is loaded.

For example, rather than directly specifying a network address for a selectable region 210 in the HTML area tag (e.g., using the “href” attribute of the area tag), a variable may be utilized to assign a value to the href attribute of an HTML area tag. To determine the value that is to be assigned to the variable, the address identifier 310 may retrieve a value from a database 340 on the host server 120. The value read in from the database 340 may represent a string that specifies a network address that is to be assigned to the href attribute.

The value of the network address in the database 340 may be modified or updated in order to modify the network address associated with a selectable region 210. In certain embodiments, an interface may be presented to the user or website designer (e.g., by the product identifier 350) that allows data relating to mapped images 150 to be displayed and modified. For example, a mapped image 150 may be selected using the interface and the data associated with the mapped image 150 in the database 340 may be displayed and modified. This may include modifying the network addresses that are associated with selectable regions 210 of the mapped image 150, or modifying coordinates and shapes of the selectable regions 210.

In certain embodiments, the address identifier 310 or other component may automatically update the network address information in the database 340 for a selectable region 210 in response to certain events. For example, pricing information for a particular product may be monitored across different merchant websites 165 and the address identifier 210 may select the network address of the merchant website 165 having the lowest price for the product to be associated with the selectable region 210 of a mapped image 150. Thus, in response to detecting a price drop on a merchant website 165, the address identifier 310 may update the network address in the database 340 that is associated with the selectable region 210 for the product in the mapped image 150.

The address identifier 310 may update the network address information in the database 340 in response to other events as well. For example, in certain embodiments, the advertising system 130 may permit merchants or vendors to bid on or purchase selectable areas 210 associated with particular products. For example, a merchant that submitted the highest bid for a particular product may be permitted to specify or provide a network address that is to be associated with a selectable region 210 for the product. Thus, the network address information stored in the database 340 may be updated in response to bids and purchases made by merchants. It should be recognized that the network address information may be updated in response to other types of events as well.

A product preview feature 320 may also be included as part of the advertising system 130 to provide information about a product that is displayed in an image 150 without requiring a user 105 to navigate to the network address associated with a selectable region 210. For example, suppose a user 105 saw a product in an image that the user 105 was interested in purchasing or finding out more information. In response to detecting an HTML event or user input, information may be displayed about the product to the user 105 (e.g., which may include the product name, product description, pricing information and an image for the product).

As mentioned above, FIG. 2 illustrates an exemplary product preview window 250 that is overlaid on top of an image 150 being displayed in a web browser. In the exemplary image of FIG. 2, the product preview window 250 is displaying information associated with the woman's bag in the image. In other embodiments, the product preview window 250 may represent a pop-up window.

The product preview window 250, which is not part of the actual mapped image 150, may be displayed in response to different events. In certain embodiments, the product preview window 250 is displayed in response to a user scrolling over a selectable area 210. For example, the product preview window 250 may be displayed in response to detecting an HTML on MouseOver event in a selectable area 210. In other embodiments, the product preview window 250 may be displayed in response to a user clicking (e.g., left mouse click or right mouse click) on a selectable area 210 or tapping on the selectable area in the case that a touch screen device is being used. However, the product preview window 250 may be displayed in response to any HTML event that is defined in a version of any HTML specification, including but not limited to window events (e.g., on Load event), form events (e.g., onInput event), keyboard events (e.g., on KeyDown event), mouse events (e.g., onClick event), and media events.

A coordinate scaler 330 may also be utilized to determine a set of coordinates for one or more selectable regions 210 of a mapped image 150. In certain embodiments, a set of coordinates associated with a selectable region 210 of the image 150 may be directly defined within a web page or related file (e.g., by assigning static values to the “height” and “width” attributes of an HTML image tag or CSS stylesheet). In other embodiments, the coordinate scaler 330 may determine a set of coordinates associated with a selectable region 210 each time a web page including the image 150 is loaded. In the case that the dimensions of the image have changed, a scaling function may be applied to define a new set of coordinates for the image 150. The scaling function may utilize an original set of dimensions and an original set of coordinates as inputs to compute a new set of coordinates for a mapped image 150 having modified dimensions.

For example, suppose an original set of coordinates for an image having a first set of dimensions was initially determined (e.g., determined by a feature of the product identifier 250 that automatically determines the coordinates based on a user clicking on portions of an image or determined by a developer that has input the dimensions). The first set of dimensions and coordinates may be stored in a database 250 along with data that indicates the shape of the selectable region 210. In response to detecting that the dimensions for the image have been modified (e.g., in response to adjusting the “height” and “width” attributes of a HTML image tag or adjusting related CSS values), the scaling function provided by the coordinate scaler 330 may compute a second set of coordinates for the image which correspond to the portions of the resized image that identify the product. Thus, if the dimensions of an image are altered, the coordinates defining a selectable region can also be altered accordingly to ensure that the selectable region 210 covers the portion of the image that identifies the product.

As a simple example, suppose the coordinates of a rectangular selectable region 210 of an image were originally determined to be 2,2,10,10 for a product in an image that was 50×50. Then suppose that image size was doubled to 100×100 (e.g., perhaps because the height and width attributes of an image tag were specified as a percentage value). The coordinate scaler 330 may compute a new rectangular selectable region 210 for the product that has the coordinates 4,4,20,20. Thus, rather than using static values to define the selectable region 210 for a product in an image, variables may be utilized to define the coordinates of the selectable region 210 and the variables can be adjusted accordingly when the dimensions on a mapped image 150 are modified.

Below is exemplary block of PHP pseudocode that may be utilized to determine the coordinates of a selectable region in accordance with certain embodiments of the present principles.

### Pseudocode Example #2:

```
<?php
$imageName = “sampleImage.jpg”;
$currentImageSize = getimagesize($imageName);
$originalImageSize = getOriginalImageSize($imageName);
$originalCooridnates = getOriginalCoordinates($imageName);
$coordinateShape = getShape($imageName);
if(compareDim($currentImageSize, $originalImageSize)){
      $coordinates = $originalCoordinates;
}
else{
      $rescaledCoordinates = recomputeCoordinates($originalImageSize,
$currentImageSize, $originalCooridnates, $coordinateShape);
      $coordinates = $rescaledCoordinates;
}
echo ‘
<img src=“sampleImage.jpg” width=“600” height=“600” alt=“sample”
usemap=“#sample”>
<map name=“sample”>
      <area shape=“$coordinateShape” coords=“$coordinates”
alt=“product” href=“http://www.merchant1.html”>
</map>
‘;
?>
```

Pseudocode Example #2 demonstrates exemplary principles for computing coordinates of a selectable area. The $imageName variable is assigned a value that identifies the name of the image for which the coordinates are being computed. The getimagesize( ) function retrieves the current dimensions of the image. The getOriginalImageSize( ) getOriginalCoordinates( ) and getShape( ) functions retrieve values from a database 340 specifying the original image dimensions, original set of coordinates, and original coordinate shape (e.g., circle, rectangle or polygon). The function compareDim( ) compares the current dimensions of the image with the original dimensions for the image. If the current dimensions match the original dimensions, the original coordinates are used to define the selectable region 210 for the image. Otherwise, the recomputeCoordinates( ) function computes a new set of coordinates for the selectable region 210 using four inputs: the original dimensions of the image 150, the current dimensions of the image 150, the original set of coordinates for the selectable region 210, and the coordinate shape for the selectable region 210. In certain embodiments, re-computing the coordinates may include scaling the coordinates of a selectable region 210 proportionately to the change in image dimensions. The coordinates may be computed in other ways as well.

Moving on, the advertising system 130 may also include an activity tracking system 340 that monitors and records data relating to 105 activities of a user 105 on the host server 120 or host website 140. This may include monitoring activities associated with interacting with a mapped image 150. Each time a user 105 provides an input to a selectable region 210 on the image (e.g., clicks on a selectable region 210 or scrolls over a selectable region 210), activity data may be recorded (e.g., recorded within database 340). For example, data may be recorded which identifies the IP address of the user 105, the product associated with the selectable region 210, the network address associated with the selectable region 210, the physical location of the user 105, a timestamp indicating the time that the input was received, and other types of related information. In the case that the user 105 was logged into an account on the host website 140, data may also be recorded that relates to the user's account (e.g., such as a user ID or other information related to the user or the user's account).

The data recorded by the activity tracking system 340 may be utilized in a variety of different ways. In certain embodiments, the data may be associated with a user 105 and analyzed to identify the interests or shopping patterns of the user 105. The data may be associated with the user using the IP address and/or user ID of the user. The advertising system 130 may present advertisements to the user based on the user's interests and/or shopping patterns that are identified by the recorded activity data, or may recommend other products and services to the user 105 based on this data. In certain embodiments, a user's recorded activity data may be compared to the interests and/or shopping patterns of other users that interact with the host website 140 to determine which advertisements or suggestions should be presented to the user 105. The activity data may further be used to determine whether advertising goals are being met (e.g., by determining how many users have been forwarded to merchant sites) and to analyze trends of users that are accessing the website 140 on the host server 120.

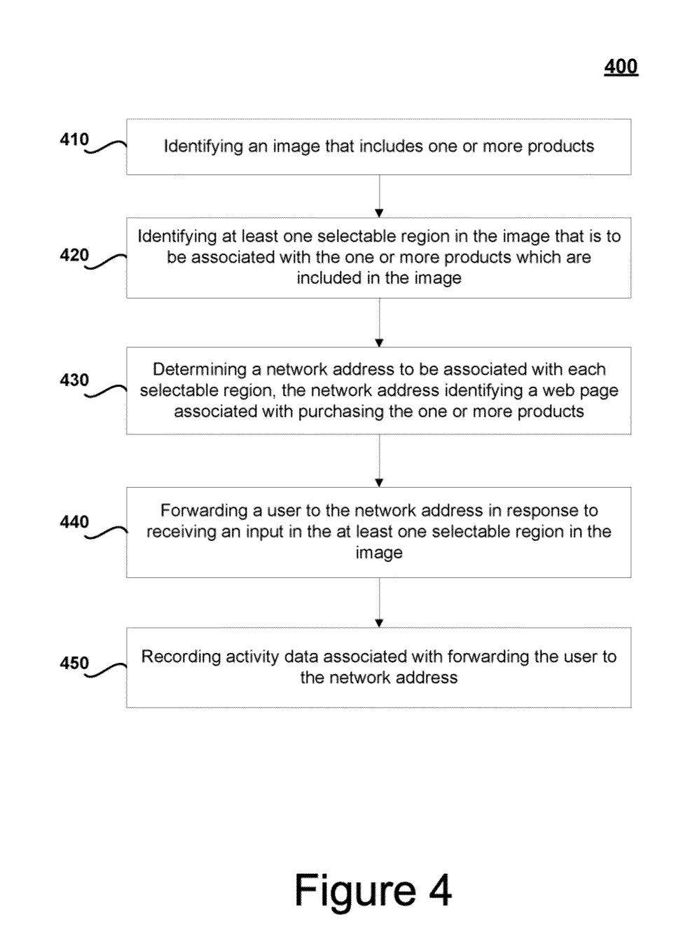

FIG. 4 illustrates an exemplary method 400 for providing an advertising service in accordance with certain embodiments of the present invention. Initially, an image including one or more products is identified (step 410). The image may be identified in various ways. For example, a user may identify an image using the “src” attribute of an HTML image. In certain embodiments, a user may identify the image with an automated tool (e.g., the automated product identifier 350) that facilitates the creation of a mapped image 150. Identifying an image may also include uploading an image to a server or selecting an image with a website development application.

At least one selectable region 210 is identified in the image that is to be associated with the one or more products included in the image (step 420). The selectable region 210 may be identified using coordinates and a corresponding shape (e.g., circle, rectangle or polygon) that is associated with the coordinates. In certain embodiments, the selectable region 210 may be identified manually by a developer or other person. In further embodiments, the selectable region 210 may be identified using the automated product identifier 350 described above.

Next, a network address to be associated with each selectable region 210 is determined (step 430). The network address may identify a web page associated with purchasing the one or more products. In addition, determining a network address associated with a selectable region 210 may include retrieving an address explicitly specified in a web page file. In other embodiments, determining a network address associated with a selectable region 210 may include dynamically retrieving a network address from a database 360 in response to loading a web page or in response to receiving user input in the selectable region 210.

In response to receiving an input in the at least one selectable region 210 in the image, a user (or user's browser) is forwarded to the network address associated with the selectable region 210 (step 440). As explained above, the network address may identify a web page on a merchant's website 165 that lists a product for sale, a web page that provides a detailed description of the product, a checkout page on a merchant website that permits the user 105 to purchase the product, a web page that displays an electronic shopping cart which includes the product associated with the selectable region 210 in the shopping cart, a homepage for the merchant website 165 or other type of web page.

As an optional step, activity data may be recorded that is associated with forwarding the user to the network address (step 450). For example, the activity data may identify a user (e.g., by a username or user ID associated with a host website, an IP address, etc.), the product associated with the selectable region 210 which was selected by the user, the network address the user was forwarded to, and other types of activity data associated with the user's interaction with a host website 130. As explained above, the recorded activity data may be utilized for various purposes (e.g., to monitor user activity on the host website 130 or host server 120, to select advertisements to be displayed to the user, etc.).

While there have shown and described and pointed out various novel features of the invention as applied to particular embodiments thereof, it will be understood that various omissions and substitutions and changes in the form and details of the systems and methods described and illustrated, may be made by those skilled in the art without departing from the spirit of the invention. Amongst other things, the steps shown in the methods may be carried out in different orders in many cases where such may be appropriate. Those skilled in the art will recognize, based on the above disclosure and an understanding therefrom of the teachings of the invention, that the particular hardware and devices that are part of the system described herein, and the general functionality provided by and incorporated therein, may vary in different embodiments of the invention. Accordingly, the particular system components shown in the figures are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation, and the present invention is limited only by the claims which follow.

What is claimed is:

1. A system for providing an advertising service, comprising:
a processor configured to:
transmit a mapped image that displays a product and includes a selectable region to a user over a network for display in a web browser, the selectable region covering at least a portion of the mapped image which includes the product and being associated with a set of image coordinates that identify the portion of the mapped image;
determine a network address that is associated with the selectable region of the mapped image, the network address identifying a web page associated with purchasing the product; and
transmit data over the network for detecting an input in the selectable region of the mapped image from the user and for forwarding the user to the web page associated with the network address in response to detecting the input in the selectable region of the mapped image.

2. The system of claim 1, wherein the web page associated with purchasing the product comprises:
a web page on a merchant website that lists a product for sale;
a web page that provides a detailed description of the product;
a checkout page on a merchant website that permits the user to purchase the product; or
a web page on a merchant website that displays an electronic shopping cart which includes the product associated with the selectable region in the shopping cart.

3. The system of claim 1, wherein the processor is further configured to:
record activity data associated with forwarding the user to the network address associated with the selectable region.

4. The system of claim 1, wherein the processor is further configured to:
scale the set of image coordinates associated with the selectable region in response to detecting a change in dimensions for the mapped image.

5. The system of claim 1, wherein the selectable region is identified using an automated tool that provides an interface that permits an individual to identify the selectable region associated with the product and to associate the network address with the selectable region.

6. The system of claim 1, wherein the processor is further configured to:
transmit data associated with providing a product preview feature, the product preview feature displaying data associated with the product to the user without requiring the user to navigate to the network address associated with the selectable region.

7. The system of claim 6, wherein the product preview feature is displayed as an overlay element on an interface that includes the mapped image and is displayed in response to detecting a cursor in the selectable region.

8. The system of claim 1, wherein code associated with providing the advertising service is included within one or more web pages associated with a host website that includes the mapped image on one or more web pages.

9. A method for providing an advertising service, comprising:
transmitting, with a processor, a mapped image that displays a product and includes a selectable region to a user over a network for display in a web browser, the selectable region covering at least a portion of the mapped image which includes the product and being associated with a set of image coordinates that identify the portion of the mapped image;
determining a network address that is associated with the selectable region of the mapped image, the network address identifying a web page associated with purchasing the product; and
transmitting data over the network for detecting an input in the selectable region of the mapped image from the user and for forwarding the user to the web page associated with the network address in response to detecting the input in the selectable region of the mapped image.

10. The method of claim 9, wherein the web page associated with purchasing the product comprises:
a web page on a merchant website that lists a product for sale;
a web page that provides a detailed description of the product;
a checkout page on a merchant website that permits the user to purchase the product; or
a web page on a merchant website that displays an electronic shopping cart which includes the product associated with the selectable region in the shopping cart.

11. The method of claim 9, further comprising:
recording activity data associated with forwarding the user to the network address associated with the selectable region.

12. The method of claim 9, further comprising:
scaling the set of image coordinates associated with the selectable region in response to detecting a change in dimensions for the mapped image.

13. The method of claim 9, wherein the selectable region is identified using an automated tool that provides an interface that permits an individual to identify the selectable region associated with the product and to associate the network address with the selectable region.

14. The method of claim 9, further comprising:
transmitting data associated with providing a product preview feature, the product preview feature displaying data associated with the product to the user without requiring the user to navigate to the network address associated with the selectable region.

15. The method of claim 14, wherein the product preview feature is displayed as an overlay element on an interface that includes the mapped image and is displayed in response to detecting a cursor in the selectable region.

16. The method of claim 9, wherein code associated with providing the advertising service is included within one or more web pages associated with a host website that includes the mapped image on one or more web pages.

17. A non-transitory computer storage medium comprising program instructions for providing an advertising service, wherein the program instructions, when executed on a computer, cause the computer to:
transmit a mapped image that displays a product and includes a selectable region to a user over a network for display in a web browser, the selectable region covering at least a portion of the mapped image which includes the product and being associated with a set of image coordinates that identify the portion of the mapped image;
determine a network address that is associated with the selectable region of the mapped image, the network address identifying a web page associated with purchasing the product; and
transmit data over the network for detecting an input in the selectable region of the mapped image from the user and for forwarding the user to the web page associated with the network address in response to detecting the input in the selectable region of the mapped image.

18. The computer storage medium of claim 17, wherein the web page associated with purchasing the product comprises:
a web page on a merchant website that lists a product for sale;
a web page that provides a detailed description of the product;
a checkout page on a merchant website that permits the user to purchase the product; or
a web page on a merchant website that displays an electronic shopping cart which includes the product associated with the selectable region in the shopping cart.

19. The computer storage medium of claim 17, wherein the selectable region is identified using an automated tool that provides an interface that permits an individual to identify the selectable region associated with the product and to associate the network address with the selectable region.

20. The computer storage medium of claim 17, wherein the selectable region is identified using an automated tool that provides an interface that permits an individual to identify the selectable region associated with the product and to associate the network address with the selectable region.
